(19) United States
(12) Patent Application Publication
(10) Pub. No.: US 2008/0037448 A1
(43) Pub. Date: Feb. 14, 2008

(54) ESTABLISHING A FLOOR GRANT IN A PUSH-TO-TALK OVER CELLULAR COMMUNICATION NETWORK

(75) Inventors: Sean S. Kelley, Barrington, IL (US); John M. Harris, Glenview, IL (US); Johanna A. Wild, Muenchen (DE)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/828,596

(22) Filed: Jul. 26, 2007

Related U.S. Application Data
(60) Provisional application No. 60/821,843, filed on Aug. 9, 2006.

(51) Int. Cl. H04L 12/16

(52) U.S. Cl. 370/270; 455/519

(57) ABSTRACT

A method and system establishing a floor grant in a Push-to-Talk over Cellular (PoC) communication network includes a first step of initiating a PoC session. A next step includes associating a floor grant parameter with the PoC session. A next step includes determining the floor grant parameter associated with the PoC session. A next step includes mapping the floor grant parameter to a predefined floor control scheme. A next step includes operating the PoC session with the floor control scheme. The present invention allows floor control schemes other than the commonly known floor grant to the caller initiating a PoC session.

### FIELD OF THE INVENTION

The present invention relates generally to wireless group communication sessions and more specifically to a method and system for establishing one or more floor grants in a Push-to-Talk over Cellular communication network.

### BACKGROUND OF THE INVENTION

Multimedia and group communications have become an important aspect of telecommunications, and the demand for such continues to increase. For instance, the Open Mobile Alliance (OMA) has developed a suite of protocols that are designed for use in multimedia and group communications. These protocols include a Session Initiation Protocol (SIP) and a Session Description Protocol (SDP), which can be used to establish Push-to-Talk over Cellular (PoC) communications.

Since its approval in early 1999 as an official standard, SIP has gained tremendous market acceptance for signaling communications services on the Internet. As such, numerous products incorporate the SIP standard, including but not limited to SIP desktop telephones, SIP telephony servers, and personal computing devices running SIP applications. SIP is a text-based signaling transactional protocol, similar to Hypertext Transfer Protocol (HTTP) and Simple Mail Transfer Protocol (SMTP), and works in the Application layer of the Open Systems Interconnection (OSI) communications model. A SIP message is used to initiate an interactive communications session, such as voice, video, and chat, between participants in a session in a communications network. Each participant is typically associated with a communications device (also referred to herein as a terminal device or an endpoint) that is connected to the network. A “participant” need not be a person, but can simply be a communication device with a suitable address.

SIP is not only used to initiate sessions, SIP messages are also used to terminate and to modify sessions. SIP does not, however, actually define what a “session” is, e.g., which Internet Protocol (IP) channel (addresses and ports), media codec specification, floor control channels, etc., are to be used during the session. This is described by content carried in the SIP messages. SIP conveys information about the protocol used to describe the session through multipurpose Internet mail extensions (MIME), widely used in web and e-mail services to describe content (HTML, audio, video, etc.).

SIP is based on the request-response paradigm. Thus, to initiate a session, a caller who is associated with an initiating endpoint sends a request (called an SIP INVITE) addressed to one or more callees, associated with a recipient endpoint(s), that the caller wants to talk to. In SIP, addresses are Uniform Resource Locators (URLs). SIP defines a URL format that is very similar to the popular mailto URL. For instance, if the user's e-mail address is janedoe@company.com, the SIP URL would be sip:janedoe@company.com. Once the user has been located and the session description delivered, SIP is used to convey the response to the session initiation (accept, reject, etc.). If accepted (via a SIP 200 OK), the session is now active, wherein a SIP ACK is then sent from the initiating endpoint to the recipient endpoint. At this point, the caller has a floor grant to begin talking

In SIP, a successful SIP INVITE/200 OK/ACK exchange creates a SIP control dialog (also referred to as a SIP dialog, a call leg or a SIP transaction). Once a session is active, SIP can be used to modify the session as well. To modify a session, the initiating endpoint simply re-initiates the session, sending the same message as the original, but with a new session description or updates the session parameters. For this reason, modification of sessions (which includes things like adding and removing audio streams, adding video, changing codecs, hold and mute) are easily supported with SIP, so long as the session description protocol can support them (SDP supports all of the above). Finally, SIP can be used to terminate the session. Sending a SIP BYE message performs this function.

SIP can be used to setup both one-way and full-duplex sessions. For one-way communication sessions, there is a need for floor control. This is the case for Push-to-Talk over Cellular (PoC) Sessions, as standardized by OMA. The Floor Control Protocol in PoC is used to communicate in real time to PoC Session participants who is allowed to send Talk Bursts or Media Bursts, to be distributed to all other participants. This is done by using a Floor Grant message sent to a specific participant.

In a PoC Session, the floor grants are typically given to the session initiating caller. It is also known to provide a floor grant to predefined, privileged users who can preempt the floor. It is also known to provide floor grants based on a queuing system where the floor grant is passed to participants in the queue. In this instance, the queuing can be based on a request priority and/or a request time. However, there are many scenarios where a floor grant is more suitably provided to a participant other than the caller. For example, a callee may not want to communicate with the caller upon session initiation, and immediately communicate this fact to the caller. In another example, in an emergency situation other devices should be granted the floor other than the initiating device.

Therefore, there exists a need for a method and a system for establishing one or more floor grants for participants other than the caller. It would also be of benefit if various session floor control schemes can be addressed for present and future scenarios.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 is a flow diagram illustrating a generalized system for establishing floor grants, in accordance with the present invention;

FIG. 2 is a flow diagram illustrating a first embodiment for establishing floor grants, in accordance with the present invention;

FIG. 3 is a flow diagram illustrating a second embodiment for establishing floor grants, in accordance with the present invention;

FIG. 4 is a flow diagram illustrating a third embodiment for establishing floor grants, in accordance with the present invention; and

FIG. 5 is a flow chart illustrating a method for establishing floor grants, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF THE PREFERRED EMBODIMENT

The present invention provides a method and a system for establishing one or more initial and subsequent floor grants for participants other than the caller. In certain PoC calls, the present invention provides that a called user (rather than calling user) speak or transmit media first. For example, a user who is manually answering a PoC call may want the floor (i.e. to say “call me back in a few minutes”), regardless of whether the calling user has already requested the floor.

In the prior art, after PoC session establishment, the floor is granted to the first request. In an OMA PoC call, the initial SIP INVITE is considered an implicit floor request, so the calling user can always obtain the floor first. The only known mechanisms for a called user to then get the floor are: a) the calling user is done speaking and releases the floor, or b) the called user is “privileged” and is allowed to preempt the floor, or only gets the floor in queue.

Advantageously, the present invention provides that a called user can be given the opportunity to speak immediately (and potentially not receive media from the calling user), regardless of whether the calling user has requested the floor.

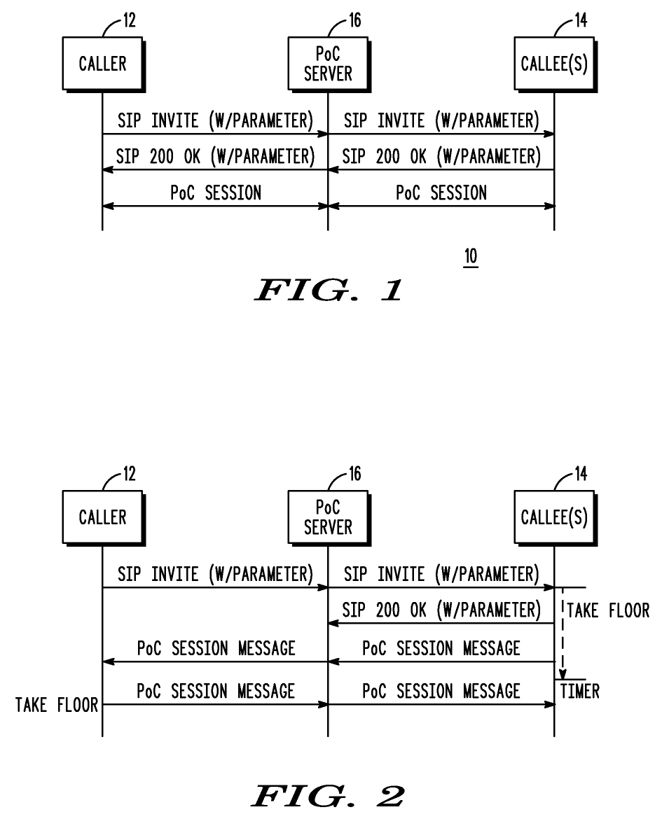

FIG. 1 illustrates a method flow in a generalized Push-to-Talk over Cellular (PoC) communications network system 10 that uses a method for establishing one or more floor grants in a network of users, in accordance with the present invention. The system 10 includes a caller 12 who initiates a PoC session and one or more other participants or callees 14. The session is controlled by a controller, such as PoC server 16, that represents a logical point of control for all voice and media sessions between the participants 12, 14. The term “participants” as used herein includes persons or devices associated with a particular address, and can be, but is not limited to, one of the following communications devices: cellular radiotelephones, wireless Personal Data Assistants, mobile computers, and desktop terminals.

The PoC server 16 is preferably a specialized SIP entity that combines a SIP user agent client, a SIP user agent server. Session initiation, modification, and termination are controlled by SIP messages addressed to the PoC server. The PoC server maintains a session directory of all active sessions within a group's context and informs affiliated participants of the current state of any sessions via unicast SIP signaling.

The system 10 is simplified for purposes of illustrating the present invention. However, those of ordinary skill in the art will realize that system 10 may be designed to include a much larger number of participants and associated terminal devices. The system 10 can be, for instance, a dispatch system for use in public safety that includes a plurality of dispatch groups of varying sizes, wherein each dispatch group has a correlating group entity for mediating sessions between a plurality of endpoints affiliated with the respective group. The dispatch system may also include additional entities not shown to further increase the system's efficiency. These additional entities may be configured to assist the group entities in arbitration and mediating sessions for group communications.

FIG. 2 illustrates a caller 12 initiating, via the server 16, a session with the participant(s) 12, 14, in accordance with the present invention. To initiate the session, the caller 12 preferably sends a SIP INVITE message addressed to a callee or group 14. A session description is carried in the payload of the SIP INVITE message and is used to describe any requested session parameters. Typically, the session description for a given group communication contains any one of a single media stream, multiple media streams, or multiple synchronized media streams (e.g., QuickTime). For instance, the session description could indicate that the user desires to start a session with an H.263 video stream and an IMBE audio stream.

In accordance with a first embodiment of the present invention, an attribute is also added to the SIP INVITE indicating a particular floor control scheme to use. In another second embodiment, the attribute is added to the SIP 200 OK message from a callee indicating a particular floor control scheme to use. In yet another third embodiment, the server can have a predefined attribute stored therein that can be assigned to particularly identified group sessions.

The attribute is a floor grant parameter associated with the PoC session. Preferably, the floor grant parameter is a Universal Resource Identifier (URI) parameter of a SIP session and the floor control scheme is a Media Burst Control Protocol (MBCP) scheme. The PoC server can determine the floor grant parameter associated with the PoC session, and map the floor grant parameter to a list of predefined floor control schemes which define how floor grants can be arbitrated or mediated in that session, whereupon the server operates the PoC session with the floor control scheme corresponding to the floor grant parameter.

Referring to FIG. 2, in the first embodiment, the caller 12 sends an SIP INVITE with the floor grant parameter to a PoC server 16. In this embodiment, the PoC server recognizes that the parameter gives floor rights to a callee(s) of the session. For example, the server can read a particular header value of the SIP INVITE that includes the particular floor grant parameter. The PoC server then passes the SIP INVITE with the floor grant parameter to the callee(s) 14. The callee 14 can then press the Push-to-Talk (PTT) button to acknowledge the invite with a SIP 200 OK message using the parameter to indicate that it is taking the floor. In this case, the implicit floor request from the caller, as recognized by the PoC server, may be dropped from queue, or any spooled audio may be discarded. The callee can then immediately send a message to the caller (e.g. “sorry, I'll call back in a few minutes”) and end the call. Optionally, a timer can be included, wherein if the callee does not respond to a caller with a SIP 200 OK message within a predetermined time the caller (or first requesting participant of a group call) can take control of the floor.

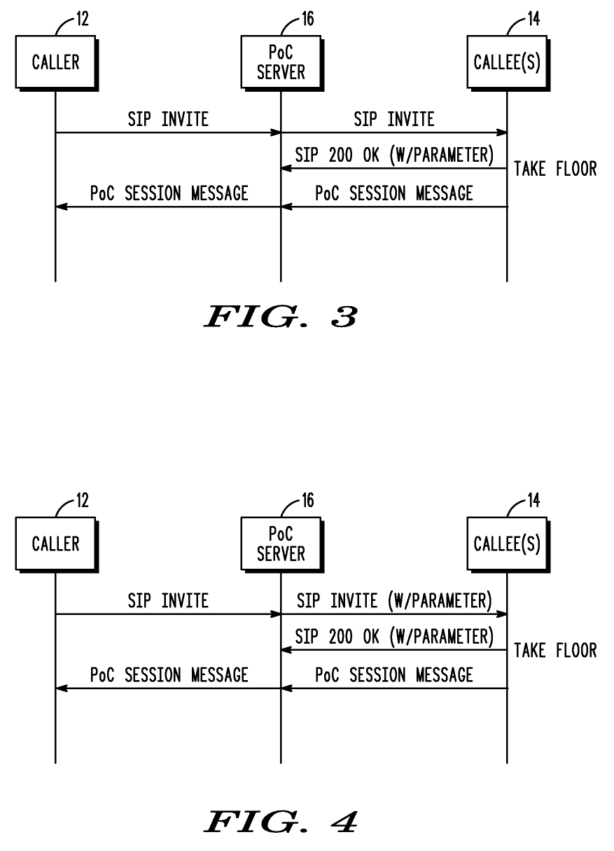

Referring to FIG. 3, in the second embodiment, the caller 12 sends an SIP INVITE without a floor grant parameter to a PoC server 16. The PoC server then passes the SIP INVITE without the floor grant parameter to the callee(s) 14. The callee 14 can then acknowledge the invite with a SIP 200 OK message with the floor grant parameter to indicate that it is taking the floor. In this embodiment, the PoC server recognizes that the parameter gives floor rights to a callee(s) of the session, whereupon the callee can immediately send a message to the caller (e.g. “sorry, I'll call back in a few minutes”) and then ends the call. Optionally, a timer (not shown) can be included, as in the first embodiment.

Referring to FIG. 4, in the third embodiment, the caller 12 sends an SIP INVITE without a floor grant parameter to a PoC server 16. The PoC server recognizes the group identified in the SIP INVITE (e.g. via the PoC Group Identity) as one having special floor grant rules (e.g. stored in the PoC XML Document Management Server (XDMS)). The server then passes the SIP INVITE with the associated floor grant parameter to the callee(s) 14. The callee 14 can then acknowledge the invite with a SIP 200 OK message with the floor grant parameter to indicate that it is taking the floor, whereupon the callee can immediately send a message to the caller (e.g. “sorry, I'll call back in a few minutes”) and then ends the call. Alternatively, a preconfigured address can be assigned the initial floor (e.g. to an emergency server playing pre-stored instructions to the PoC session participants). Optionally, a timer (not shown) can be included, as in the first embodiment.

The floor control schemes of the present invention can identify not only the initial floor grant, but can also identify subsequent floor grants once a PoC session is established. For example, a predefined floor control scheme can be implemented wherein the floor is distributed to participants of a group based on a presence state of the participants. In this case, the floor can be assigned to group participants that are “present” in the session, and not assigned to those participants whose presence state is not available, or is expired.

In addition, there can be data gather sessions that can use the floor control schemes of the present invention to advantage. For example, in a car accident the floor can be granted serially among a list of addresses of various sensors in the car in order to gather data therefrom. In particular, a call from a vehicle that has crashed can first include an indicator of how severe the crash is. This severity indicator can be used to serially assign the floor to different sets of sensors in the car, such as the speakerphone in the vehicle or to the various sensors in the vehicle to transmit data to the road assistance center.

In another example, in industrial applications, a list of addresses can be assigned the floor in prioritized round-robin (serial) fashion to get data from a list of relevant sensors. This can be useful for PoC Crisis Management sessions initiated by machines like fire sensors, chemical sensors or water level sensors, wherein the floor is assigned depending on the crisis scenario, to a crisis management server which would play pre-stored instructions or to specific pre-configured sensors to transmit data to the emergency center.

In another example, a PoC Session to a medical emergency center and/or the police can be initiated by an impaired person, assigning the floor to a data storage device capable for displaying the medical record of the initiator.

It is envisioned that the floor control rules in one PoC session can be used to define different floor assignment rules for different Media in the PoC session. For example, in Push-to-X sessions, an initiating voice session can define who should have the floor in an accompanying video streaming session (e.g. parents can start a session directing a secondary video streaming session to come from a specific address such as a kindergarten/bedroom of their children to their workplace desktop computer).

In another example, a floor control scheme can be defined wherein the participants of a group session can subsequently vote on a first-come-first-floor-grant scheme without queuing of floor requests from the part of the participants. For example, in a chat group call initiated by any participant, a participant can vote based on the time he joined the session.

In another example, callees can be assigned the floor at predefined times based on queued requests. In another example, the floor can be locally granted, under the assumption that in a 1-1 session, when the floor is released by one participant, the floor is likely to be requested by the other participant. Alternatively, a subset of users of a dispatch call can be given the floor under defined arbitration rules under control of the PoC server. In another alternative, an arbiter or moderator of a group session can set floor assignment rules for a PoC Session and his participants based on the different roles the participants have.

The present invention envisions predefined floor control schemes stored in a server that standardize the definition of the Floor Control Protocol (FCP), Talk Burst Control Protocol (TBCP) and Media Burst Control Protocol (MBCP) Schemes to be used in PoC sessions. The floor grant parameter can be considered a novel “Arbitration Mode” parameter to choose between the particular floor control schemes. The first set of floor control protocol (FCP) schemes can be defined as follows:

Dispatched: Dispatcher gets the floor after establishment

Pre-Granted: Floor is locally granted

Alerted: Called party gets the floor after establishment

Round-robin: Called parties get the floor in a serial fashion

Quiz: Called parties get the floor a pre-defined time based on queued requests

Pre-defined: Pre-defined called party gets the floor

Moderated: Floor assignment based on statically or dynamically defined set of rules.

### It should be recognized that other schemes can be added to the list as new scenarios arise to be supported.

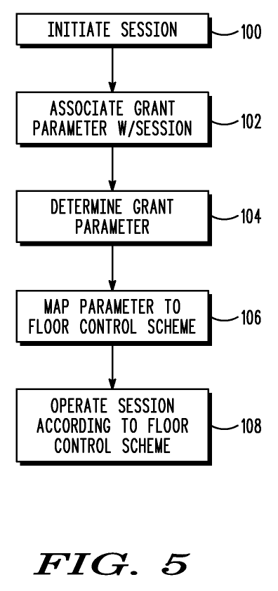

Referring to FIG. 5, the present invention includes a method for establishing a floor grant in a Push-to-Talk over Cellular (PoC) communication network. The method includes a first step 100 of initiating a PoC session. This step can include sending a Session Initiation Protocol Invite (SIP INVITE) from an initiating caller including the floor grant parameter. Alternatively, a predetermined group for the PoC session can be defined, wherein the predefined floor control scheme includes rules for floor granting for the group.

A next step 102 includes associating a floor grant parameter with the PoC session. Specifically, the floor grant parameter is a Universal Resource Identifier (URI) parameter of a Session Initiation Protocol (SIP) and the floor control scheme is a FCP, TBCP or Media Burst Control Protocol (MBCP) scheme. This step can include receiving a PoC 200 OK message from a responding callee including the floor grant parameter.

A next step 104 includes determining the floor grant parameter associated with the PoC session. This can be accomplished by reading a header value from a URI parameter included in the SIP INVITE message.

A next step 106 includes mapping the floor grant parameter to a predefined floor control scheme. This step can include predefined floor control scheme wherein a callee is granted an initial floor for the session. Alternatively, the mapping step includes a predefined floor control scheme wherein a preconfigured address is granted an initial floor for the session. In yet another alternative, the mapping step includes a predefined floor control scheme wherein the floor is distributed to participants of a group based on a presence state of the participants. In yet another alternative, the mapping step includes a predefined floor control scheme including a list of addresses wherein the floor is granted serially among the list of address. In yet another alternative, the mapping step includes a predefined floor control scheme wherein the participants of a group session can subsequently vote to change the predefined floor control scheme. In yet another alternative, the mapping step includes a predefined floor control scheme wherein a dispatcher is given the floor after the session is established. In yet another alternative, the mapping step includes a predefined floor control scheme wherein a subset of users of a dispatch call are given the floor under defined arbitration rules. In yet another alternative, the mapping step includes a predefined floor control scheme wherein a moderator of a group session can set floor assignment rules. In yet another alternative, the mapping step includes a predefined floor control scheme wherein callees are assigned the floor at predefined times based on queued requests. In yet another alternative, the mapping step includes a predefined floor control scheme wherein the floor is locally granted.

A next step 108 includes operating the PoC session with the floor control scheme.

The method can includes the further step of arbitrating between floor control schemes.

The method can also include the further step of timing the 200 OK message, wherein if the callee does not respond to a caller with the 200 OK message within a predetermined time the operating step reverts the floor control to a first request for the floor.

The method can also include the further step of the PoC session defining floor assignment rules of another PoC session.

The method can also include the further step of storing the predefined floor control schemes in a PoC XML Document Management Server (PoC XDMS).

The present invention has the advantage of reducing session signaling overhead in those cases where an initial floor grant to a call initiator is not desired. In particular, a novel floor grant parameter is used among network entities to grant the floor to participants as defined in novel floor control rules. The present invention applies not only to PoC, but can also apply to other similar systems providing Push-to-Talk and Conferencing services working in a half-duplex mode.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for establishing a floor grant in a Push-to-Talk over Cellular (PoC) communication network, the method comprising the steps of:
initiating a PoC session;
associating a floor grant parameter with the PoC session;
determining the floor grant parameter associated with the PoC session;
mapping the floor grant parameter to a predefined floor control scheme; and
operating the PoC session with the floor control scheme.

2. The method according to claim 1, further comprising the step of arbitrating between floor control schemes.

3. The method according to claim 1, wherein the floor grant parameter is a Universal Resource Identifier (URI) parameter of a Session Initiation Protocol (SIP) and the floor control scheme is a Media Burst Control Protocol (MBCP) scheme.

4. The method according to claim 1, wherein the initiating step includes sending a Session Initiation Protocol Invite (SIP INVITE) from an initiating caller including the floor grant parameter.

5. The method according to claim 1, wherein the associating step includes receiving a PoC 200 OK message from a responding callee including the floor grant parameter.

6. The Method according to claim 5, further comprising the step of timing the 200 OK message, wherein if the callee does not respond to a caller with the 200 OK message within a predetermined time the operating step reverts the floor control to a first request for the floor.

7. The method according to claim 1, wherein the initiating step includes a predetermined group for the PoC session, and wherein the predefined floor control scheme includes rules for floor granting for the group.

8. The method according to claim 1, wherein the mapping step includes a predefined floor control scheme wherein a callee is granted an initial floor for the session.

9. The method according to claim 1, wherein the mapping step includes a predefined floor control scheme wherein a preconfigured address is granted an initial floor for the session.

10. The method according to claim 1, wherein the mapping step includes a predefined floor control scheme wherein the floor is distributed to participants of a group based on a presence state of the participants.

11. The method according to claim 1, wherein the mapping step includes a predefined floor control scheme including a list of addresses wherein the floor is granted serially among the list of address.

12. The method according to claim 1, wherein the mapping step includes a predefined floor control scheme wherein the participants of a group session can subsequently vote on a first-come-first-floor-grant scheme without queuing of floor requests from the part of the participants.

13. The method according to claim 1, wherein the mapping step includes a predefined floor control scheme wherein a dispatcher is given the floor after the session is established.

14. The method according to claim 1, wherein the mapping step includes a predefined floor control scheme wherein a subset of users of a dispatch call are given the floor under defined arbitration rules.

15. The method according to claim 1, wherein the mapping step includes a predefined floor control scheme wherein a moderator of a group session can set floor assignment rules.

16. The method according to claim 1, wherein the mapping step includes a predefined floor control scheme wherein callees are assigned the floor at predefined times based on queued requests.

17. The method according to claim 1, wherein the mapping step includes a predefined floor control scheme wherein the floor is locally granted.

18. The method according to claim 1, further comprising the step of the PoC session defining floor assignment rules of another PoC session.

19. The method according to claim 7, further comprising the step of storing the predefined floor control schemes in a PoC XML Document Management Server (PoC XDMS).

20. A system for establishing a floor grant in a Push-to-Talk over Cellular (PoC) communication network, the system comprising:
means for initiating a PoC session;
means for associating a floor grant parameter with the PoC session;
means for determining the floor grant parameter associated with the PoC session;
means for mapping the floor grant parameter to a predefined floor control scheme; and
means for operating the PoC session with the floor control scheme.
